(19) United States
(12) Patent Application Publication
(10) Pub. No.: US 2015/0159062 A1
(43) Pub. Date: Jun. 11, 2015

(54) TWO PART DUAL-CURE ADHESIVE FOR USE IN ELECTRONICS

(71) Applicant: Albert M. Giorgini, Lino Lakes, MN (US)

(72) Inventor: Albert M. Giorgini, Lino Lakes, MN (US)

(21) Appl. No.: 14/233,862

(22) PCT Filed: Jul. 19, 2012
(86) PCT No.: PCT/US2012/047406

§ 371 Date: Apr. 9, 2014

Related U.S. Application Data
(60) Provisional application No. 61/510,820, filed on Jul. 22, 2011.

(51) Int. Cl. C09J 175/06; B32B 27/08; B32B 37/12; B32B 27/36; B32B 37/18; B32B 7/12; B32B 27/32

(52) U.S. Cl. CPC C09J 175/06; B32B 7/12; B32B 27/08; B32B 27/32; B32B 27/36; B32B 37/182; B32B 37/1284; B32B 2457/00; B32B 2457/10; B32B 2457/12; B32B 2457/20; B32B 2519/02; B32B 2250/03; B32B 2255/26; B32B 2037/1253

(57) ABSTRACT

The disclosure relates to a two-part dual-cure adhesive composition comprising a first Part (A) comprising a radiation polymerizable polyisocyanate prepolymer and a second Part (B) comprising a polyol. The disclosed adhesive can be used on substrates with electronic components to make electronic assemblies.

This application claims the benefit of U.S. Provisional Application No. 61/510,820, filed Jul. 22, 2012, which is incorporated herein.

### SUMMARY OF THE INVENTION

In some aspects, the present disclosure relates to a method of making an electronic assembly comprising a first substrate, a second substrate, and at least one electronic component located between the two substrates. The method includes applying a two-Part dural-cure adhesive composition to at least a portion of the first substrate. Then at least a portion of a second substrate is brought into contact with the adhesive on the first substrate. At least one of the first and second substrates includes at least one electronic component prior to applying the adhesive composition. The adhesive composition includes a radiation polymerizable polyisocyanate prepolymer (Part A) and a polyol (Part B).

In one embodiment, the radiation polymerizable polyisocyanate prepolymer is a reaction product of a radiation polymerizable compound and an aliphatic polyisocyanate prepolymer.

In some aspects, the present disclosure relates to an electronic assembly that includes a first substrate, a second substrate, at least one electronic component between the two substrates, and an adhesive where at least a portion of the first substrate is bonded to at least a portion of the second substrate by the adhesive. The adhesive includes a dual cure reaction product of a radiation polymerizable polyisocyanate prepolymer (Part A) and a polyol (Part B).

### BRIEF DESCRIPTION OF THE DRAWINGS

FIG. 1 shows a cross-sectional view of an electronic component between two substrates.

FIG. 2 shows a cross-sectional view of an electronic component between two substrates with adhesive around the edges of the assembly.

FIG. 3 shows a cross-sectional view of an electronic component between two substrates with adhesive throughout the assembly.

### GLOSSARY

In reference to the invention, these terms have the meanings set forth below:

“(Meth)acrylate” refers to acrylate, methacrylate, and mixtures thereof.

“Dual cure” refers to a composition that cures through two different mechanisms, e.g., radiation on a radiation curable functionality and a chemical reaction between isocyanate functional group(s) and hydroxyl group(s).

“Radiation polymerizable compound” refers to a compound that includes an active hydrogen and a radiation polymerizable functional group in its molecule.

“Radiation polymerizable component” refers to a compound that includes a radiation polymerizable functional group but does not include active hydrogen in its molecule.

“Aliphatic polyisocyanate prepolymer” refers to a polyisocyanate prepolymer that is a reaction product of an aliphatic isocyanate and a polyol.

### DETAILED DESCRIPTION OF THE INVENTION

### Adhesive Composition

The adhesive composition is a two-part dual cure adhesive composition that includes a first part, Part A, which includes a radiation polymerizable polyisocyanate prepolymer and optionally a polyisocyanate monomer or an isocyanate terminated prepolymer that is not radiation polymerizable; and a second part, Part B, which includes a polyol and/or an amine. The adhesive composition may also include a photoinitiator, which may be present in Part A, or Part B, or a combination thereof. Alternatively, the photoinitiator may be provided to the composition separately from Part A and Part B. Part A and Part B are preferably combined to achieve a stoichiometric ratio of isocyanate (NCO) to hydroxyl group (OH) (i.e., NCO:OH) of from about 1:1 to about 2:1, or from about 1.2:1 to about 1.6:1, or about 1.4:1. In case of an amine, the stoichiometric ratio of isocyanate (NCO) to active hydrogen in amine group is similar to that of isocyanate (NCO) to hydroxyl group (OH). Part A and Part B are preferably combined in amounts such that, prior to cure, the composition includes from about 5% by weight, or about 30% by weight, or about 50% by weight, or about 60% by weight to no greater than about 80% by weight, or no greater than about 70% by weight radiation polymerizable polyisocyanate prepolymer; up to about 50% by weight, or from about 5% by weight, or about 10% by weight to no greater than about 50% by weight, or no greater than about 40% by weight, or no greater than about 30% by weight polyisocyanate monomer or isocyanate terminated prepolymer; from about 20% by weight, or about 30% by weight to no greater than about 90% by weight, or no greater than about 70% by weight polyol; and up to about 5% by weight, or from 0.2% by weight, or 0.5% by weight to about 5% by weight, or to about 1% by weight photoinitiator, based on the weight of the composition.

Parts A and B of the adhesive composition are immediately mixed together prior to applying the adhesive. When Part A and Part B are combined, the adhesive composition preferably has a viscosity of from about 250 centipoises to about 5000 centipoises at a temperature from 65° F. to 170° F. The two parts of the dual-cure adhesive composition then react with each other over time forming crosslinks. The rate at which this reaction occurs impacts the pot life of the dual cure composition, i.e., the period during which the adhesive composition can be applied and used for its intended purpose. Preferably the dual cure adhesive composition exhibits a pot life of at least 30 minutes, or even at least 45 minutes. As indicated above, the adhesive composition continues to cure over time through the reaction of the isocyanate groups of the prepolymer (Part A) and the hydroxyl groups of the polyol (Part B).

The adhesive is referred to as a “dual cure” adhesive because the adhesive is cured by exposure to radiation and a chemical reaction between isocyanate groups and hydroxyl groups. The adhesive composition, upon exposure to radiation, preferably exhibits a lap shear strength suitable to permit handling and subsequent processing of the laminate. Preferably the adhesive composition exhibits a lap shear of at least 10 grams/square inch (g/in²), or at least 25 g/in², or at least 50 g/in², or at least about 60 g/in² after exposure to ultraviolet radiation. The cured adhesive composition also preferably exhibits a peel strength of at least 25 g/lineal inch, or even a destructive bond to the substrate to which it is bonded.

When used with electronic assemblies, the adhesive preferably exhibits certain properties. For example, the adhesive is preferably capable of being processed at low temperatures on low cost substrates. It is preferably capable of being used in an automated roll-to-roll manufacturing process. It preferably exhibits a fast attach without requiring a B-stage. The composition preferably has a long open or long set time. The composition preferably exhibits good initial strength and final bond strength to low energy materials like plastics. It is preferably flexible. It preferably exhibits good moisture and oxygen barrier performance. It is preferably optically clear and does not yellow when exposed to UV radiation or higher temperatures. It preferably exhibits low outgassing and voids. And it preferably acts as a drying agent or desiccant by consuming residual moisture inside of the sealed assembly.

Part A

The first part, Part A, of the two-part dual cure adhesive composition includes a radiation polymerizable polyisocyanate prepolymer, and optionally a polyisocyanate monomer or an isocyanate terminated prepolymer that is not radiation polymerizable. In some embodiments, the radiation polymerizable polyisocyanate prepolymer has (meth)acrylate functionality. Part A preferably includes from about 40% by weight, or about 50% by weight, or about 60% by weight to no greater than about 90% by weight, or no greater than about 80% by weight radiation polymerizable polyisocyanate prepolymer, and up to about 60% by weight, or from about 10% by weight, or 15% by weight, or 20% by weight, or 30% by weight, or 40% by weight to no greater than 60% by weight, or no greater than 50% by weight polyisocyanate monomer or isocyanate terminated prepolymer, based on the weight of Part A.

Radiation Polymerizable Polyisocyanate Prepolymer

The radiation polymerizable polyisocyanate prepolymer includes radiation curable functional groups and isocyanate functional groups. The functional groups are located pendant, terminal or a combination thereof on the prepolymer. Preferably the functional groups are located terminally on the prepolymer, i.e., the prepolymer is end capped with functional groups. The radiation polymerizable polyisocyanate prepolymer preferably includes from about 5% by weight, or about 10% by weight to no greater than about 20% by weight isocyanate functional groups, and an amount of radiation polymerizable functional groups sufficient to provide an adhesive composition that, upon exposure to radiation, exhibits an initial lap shear strength suitable for subsequent processing.

The ratio of the equivalents of radiation polymerizable functional groups to isocyanate groups in Part A preferably is from about 0.1:1 to about 5:1, or from about 0.5:1 to about 4:1, or from about 0.6:1 to about 3:1, or about 1:1. The average functionality of the radiation polymerizable, polyisocyanate prepolymer is preferably from about 1.8, or about 2 to no greater than 8, or no greater than about 4; and the number average molecular weight of the radiation polymerizable, polyisocyanate prepolymer is preferably from about 200 to about 100,000 g/mole, or from about 400 to about 50,000 g/mole, or from about 600 to about 10,000 g/mole.

The radiation polymerizable polyisocyanate prepolymer is preferably prepared by reacting a radiation polymerizable compound that includes an active hydrogen and a radiation polymerizable functional group with a polyisocyanate prepolymer, preferably in the presence of excess isocyanate. Preferably the radiation polymerizable compound is reacted with the polyisocyanate prepolymer in an amount such that from about 10% to about 80%, or from about 20% to about 70%, or from about 30% to about 60% of the isocyanate groups on the polyisocyanate prepolymer are replaced with the radiation polymerizable compound that includes the active hydrogen and the radiation polymerizable functional group.

The term “active hydrogen” refers to the active hydrogen on hydroxyl, amine, and mercapto functional groups.

Examples of radiation polymerizable functional groups include acrylate, methacrylate, alkenyl groups (e.g., vinyl, allyl, and hexenyl), vinyl ethers, vinyl esters, vinyl amides, maleate esters, fumarate esters, and styrene functional groups and combinations thereof.

Suitable radiation polymerizable compounds that include an active hydrogen and a radiation polymerizable functional group include, e.g., hydroxyalkyl acrylates and methacrylates (e.g., 2-hydroxyethylacrylate (HEA), 2-hydroxyethylmethylacrylate (HEMA), 2-hydroxypropylacrylate, 3-hydroxypropylacrylate (HPA) and 2-hydroxypropyl methacrylate, 3-hydroxypropyl methacrylate, 1,3-dihydroxypropylacrylate and 2,3-dihydroxypropylacrylate and methacrylate, 2-hydroxyethylacrylamide and methacrylamide, 2-hydroxybutyl(meth)acrylate, 4-hydroxybutyl(meth)acrylate, 2-hydroxy-3-phenyloxypropyl(meth)acrylate, 1,4-butanediol mono(meth)acrylate, 2-hydroxy alkyl(meth)acryloyl phosphates, 4-hydroxycyclohexyl(meth)acrylate, 1,6-hexanediol mono(meth)acrylate, neopentyl glycol mono(meth)acrylate, trimethylolpropane di(meth)acrylate, trimethylolethane di(meth)acrylate, pentaerythritol tri(meth)acrylate, dipentaerythritol penta(meth)acrylate; N-alkyl-N-hydroxyethylacrylamides and methacrylamides, hydroxyethyl-betacarboxyethylacrylate, hydroxyhexyl acrylate, and hydroxyoctyl methacrylate and mixtures thereof.

Useful hydroxyethylacrylates and hydroxypropylacrylates are commercially available from Dow Chemical (Midland Mich.) and Osaka Organic Chemical Industry Ltd. (Osaka, Japan). Useful hydroxybutyl acrylates are commercially available from Osaka Organic Chemical Industry Ltd. Useful hydroxy polyester acrylates are commercially available under the TONE MONOMER M-100 trade designation from Dow Chemical Company and VISCOAT 2308 from Osaka Organic Chemical Industry Ltd. Useful hydroxy polyether acrylates are commercially available under the ARCOL R-2731 trade designation from Bayer Chemicals (Pittsburgh, Pa.).

The polyisocyanate prepolymer is a reaction product of a polyisocyanate and a polyol. The amount of the polyisocyanate and the polyol in the reaction mixture is such that the ratio of isocyanate (NCO) to hydroxyl groups (OH) is about 2:1. The resulting polyisocyanate prepolymer is free of hydroxyl groups and has a number average molecular weight of from about 500 g/mole, or about 1000 g/mole, to no greater than 13,000 g/mole, or no greater than 6000 g/mole, or no greater than 4000 g/mole.

Polyisocyanates useful in the preparation of the polyisocyanate prepolymer have at least two isocyanate groups and include, e.g., aliphatic, cycloaliphatic, araliphatic, arylalkyl, alkylaryl, and aromatic isocyanates, and mixtures thereof; and diisocyanates, triisocyanates, tetraisocyanates, and mixtures thereof.

Preferred polyisocyanate prepolymers include those that are a reaction product of an aliphatic polyisocyanate and a polyol.

Useful aliphatic polyisocyanates include, e.g., 1,3-cyclopentane diisocyanate, 1,4-cyclohexane diisocyanate, 1,3-cyclohexane diisocyanate, hydrogenated MDI (i.e., dicyclohexylmethane diisocyanate, H₁₂-MDI), methyl 2,4-cyclohexanediisocyanate, methyl 2,6-cyclohexanediisocyanate, 1,4-bis(isocyanatomethyl)cyclohexane, 1,3-bis(isocyanatomethyl)cyclohexane.

Useful aromatic polyisocyanates include, e.g., diphenylmethane diisocyanate compounds (MDI) including its isomers, carbodiimide modified MDI, diphenylmethane 4,4′-diisocyanate, diphenylmethane 2,2′-diisocyanate, diphenylmethane 2,4′-diisocyanate, oligomeric methylene isocyanates, toluene diisocyanate (TDI) including the isomers thereof, isomers of naphthalene diisocyanate, isomers of triphenylmethane triisocyanate, and mixtures thereof.

Other suitable diisocyanates include, e.g., 4,4′-diphenyl diisocyanate, 4,4′-toluidine diisocyanate, dianilidine diisocyanate, 4,4′-diphenyl ether diisocyanate, 1,3-xylylene diisocyanate including 1,3-diisocyanato-o-xylene, 1,3-diisocyanato-p-xylene and 1,3-diisocyanato-m-xylene, 1,4-xylylene diisocyanate, omega,omega′-diisocyanato-1,4-diethylbenzene, isomers of tetramethylxylylene diisocyanate, di alkyldiphenylmethane diisocyanates, tetraalkyldiphenylmethane diisocyanates, 4,4′-dibenzyl diisocyanate, 1,3-phenylene diisocyanate, 1,4-phenylene diisocyanate and mixtures thereof.

Examples of additional suitable diisocyanates include 1,2-diisocyanatoethane, 1,3-diisocyanatopropane, 1,2-diisocyanatopropane, 1,4-diisocyanatobutane, 1,5-diisocyanatopentane, 1,6-diissocyanatohexane, bis(3-isocyanatopropyl)ether, bis(3-isocyanatopropyl)sulfide, 1,7-diisocyanatoheptane, 1,5-diisocyanato-2,2-dimethylpentane, 1,6-diisocyanate-3-methoxyhexane, 1,8-diisocyanatoctane, 1,5-diisocyanato-2,2,4-trimethylpentane, 1,9-diisocyanatononane, 1,10-diisocyanatopropyl ether of 1,4-butylene glycol, 1,11-diisocyanatoundecane, 1,12-diisocyanatododecane, bis(isocyanatohexyl)sulfide, 2,4-diisocyanto-1-chlorobenzene, 2,4-diisocyanato-1-nitro-benzene, 2,5-diisocyanato-1-nitrobenzene, m-phenylene diisocyanate, 1-methoxy-2,4-phenylene diisocyanate, 1-methoxy-2,4-phenylene diisocyanate, 3,3′-dimethyl-4,4′-diphenylmethane diisocyanate, 1-methyl-2,4-diisocyanatocyclohexane, 1,6-diisocyanato-2,2,4-trimethylhexane, 1,6-di-isocyanato-2,4,4-trimethylhexane, 1-isocyanatomethyl-3-isocyanato-1,5,5-trimethylcyclohexane (IPDI), chlorinated and brominated diisocyanates, phosphorus-containing diisocyanates, 4,4′-diisocyanatophenylperfluoroethane, tetramethoxybutane-1,4-diisocyanate, bisisocyanatoethyl phthalate; polyisocyanates containing reactive halogen atoms (e.g., 1-chloromethylphenyl-2,4-diisocyanate, 1-bromoethylphenyl-2,6-diisocyanate, and 3,3-bischloromethyl ether-4,4′-biphenyldiisocyanate); sulfur-containing polyisocyanates; dimeric fatty acid diisocyanates, and combinations thereof. Examples of suitable triisocyanates include 4,4′,4″-triphenylmethane triisocyanate and 2,4,6-toluene triisocyanate. One example of a tetraisocyanates is 4,4′-dimethyl-2,2′-5,5′-diphenylmethane tetraisocyanate. Another suitable isocyanate is polymethylene polyphenylene polyisocyanate.

Other useful isocyanates are disclosed in, e.g., U.S. Pat. Nos. 6,387,449, 6,355,317, 6,221,978, 4,820,368, 4,808,255, 4,775,719, and 4,352,858, and incorporated herein.

Particularly preferred diisocyanates are aliphatic isocyanate or blends of aliphatic isocyanates as they provide excellent UV stability (non-yellowing) and hydrolytic stability.

Useful commercially available aliphatic isocyanates include, e.g., DESMODUR W, DESMODUR I, and DESMODUR N 3600, all from Bayer (Pittsburgh, Pa.) and VESTANAT IPDI and VESTANAT H12MDI from Evonik Degussa (Parsippany, N.J.). Commercially available aromatic isocyanates include, e.g., aromatic isocyanates available under the trade designations MONDUR ML from Bayer Chemicals (Pittsburgh, Pa.), ISONATE 50 OP and ISONATE 125M from Dow Chemical Company (Midland, Mich.), and LUPRANATE MI from BASF (Germany).

The polyol used in the formation of the polyisocyanate prepolymer has at least two hydroxyl (OH) groups and a number average molecular weight of from about 250 g/mole, or about 500 g/mole or about 1000 g/mole to no greater than 12000 g/mole, or no greater than 4000 g/mole, or no greater than 2000 g/mole. Such polyols include polyester polyols, polyether polyols, polycarbonates and polyacetals.

Polyester polyols can be prepared by polycondensation of acid and/or anhydride with at least one alcohol, e.g., polycondensation of polycarboxylic acid or anhydride and polyol. Suitable polycarboxylic acids for use in preparing polyester polyols include, e.g., aliphatic, cycloaliphatic, araliphatic, aromatic and heterocyclic polycarboxylic acids and anhydrides. Examples of such polycarboxylic acids and anhydrides include succinic acid, adipic acid, suberic acid, azelaic acid, sebacic acid, cyclohexanediacid, glutaric acid, phthalic acid, isophthalic acid, terephthalic acid, trimellitic acid, phthalic anhydride, tetrahydrophthalic anhydride, hexahydro-phthalic anhydride, tetrachlorophthalic anhydride, endomethylenetetrahydrophthalic anhydride, glutaric anhydride, maleic acid, maleic anhydride, finnaric acid, dimeric fatty acids, trimeric fatty acid, trimellitic acid, trimellitic anhydride, and combinations thereof.

Useful polyols for preparing polyester polyols include aliphatic polyols (e.g., neopentylglycol, ethylene glycol, 1,2-propanediol, 1,3-propanediol, 1,4-butanediol, 1,3-butanediol, 2,3-butanediol, 1,4-butenediol, 1,4-butynediol, 1,5-pentanediol, 1,6-hexanediol, hexenediols, hexynediols, 1,7-heptanediol, heptenediols, heptynediols, 1,8-octanediol, octenediols, and octynediols), cyclohexane dimethanol, glycerol, trimethylolpropane, pentaerythritol, sorbitol, and glucose, and mixtures thereof. Useful polyether polyols include the reaction product of polyols and polyalkylene oxides. Useful polyols for preparing polyether polyols include ethylene glycol, propylene glycol, butanediols, hexanediols, glycerols, trimethylolethane, trimethylolpropane, and pentaerythritol, and mixtures thereof. Useful alkylene oxides for preparing polyether polyols include ethylene oxide, propylene oxide and butylenes oxide and mixtures thereof

Polyisocyanate Monomer and Isocyanate-Terminated Prepolymer.

Part A may also include additional polyisocyanate monomer or isocyanate terminated prepolymer that is not radiation polymerizable to provide excess isocyanate functionality. That is, these optional ingredients do not have a radiation polymerizable functionality in their molecules. Excess isocyanate functionality is preferably present in the adhesive composition in an amount sufficient to achieve an adhesive composition that exhibits a destructive peel when tested according to the herein described Peel Adhesion Test Method. Suitable polyisocyanate monomers include the polyisocyanates set forth above and isocyanate terminated prepolymers created from isocyanate monomers and polyols set forth above and incorporated herein. Preferably, the polyisocyanate monomer is an aliphatic isocyanate; and the isocyanate-terminated prepolymer is a reaction product of an aliphatic isocyanate and a polyol.

Part B

The second part, Part B, of the two-part dual cure adhesive composition includes a polyol, and optionally a photoinitiator. Part B preferably includes from about 70% by weight to about 100% by weight, or from about 80% by weight to about 100% by weight, or from about 90% by weight to about 100% by weight of the polyol, and from 0% by weight to about 10% by weight, or from about 0.2% by weight to about 5% by weight, or from about 0.5% by weight to about 1% by weight of a photoinitiator, based on the weight of Part B.

Polyol.

Suitable polyols for Part B include those used in the preparation of the polyisocyanate prepolymer described above e.g., diols, triols and mixtures thereof. Preferred polyols include polyester polyols, polyether polyols, polyolefin dials, polydiene block polyols, and combinations thereof. Preferred polyols have a functionality of from about 1.5, or about 2, or about 3 to no greater than 4.0, or no greater than 3.5. Preferred polyols have a Tg less than 10° C., or even less than 0° C., and a number average molecular weight of from about 500 g/mole to about 12000 g/mole, or from about 750 g/mole to about 2000 g/mole.

Useful classes of polyols include, e.g., polyester polyols including, e.g., lactone polyols and the alkyleneoxide adducts thereof, and dimer acid-based polyester polyols, specialty polyols including, e.g., polybutadiene polyols, hydrogenated polybutadiene polyols, polycarbonate polyols, hydroxy alkyl derivatives of bisphenol A (e.g., bis(2-hydroxyethyl)bisphenol A), polyether polyols including, e.g., polythioether polyols, and fluorinated polyether polyols, acrylic polyols, alkylene oxide adducts of polyphenols, polytetramethylene glycols, functional glycerides (e.g., castor oil), and polyhydroxy sulfide polymers.

Useful polyester polyols are prepared from the reaction product of polycarboxylic acids, their anhydrides, their esters or their halides, and a stoichiometric excess polyhydric alcohol. Suitable polycarboxylic acids include dicarboxylic acids and tricarboxylic acids including, e.g., aromatic dicarboxylic acids, anhydrides and esters thereof (e.g. terephthalic acid, isophthalic acid, dimethyl terephthalate, diethyl terephthalate, phthalic acid, phthalic anhydride, methyl-hexahydrophthalic acid, methyl-hexahydrophthalic anhydride, methyl-tetrahydrophthalic acid, methyl-tetrahydrophthalic anhydride, hexahydrophthalic acid, hexahydrophthalic anhydride, and tetrahydrophthalic acid), aliphatic dicarboxylic acids and anhydrides thereof (e.g. maleic acid, maleic anhydride, succinic acid, succinic anhydride, glutaric acid, glutaric anhydride, adipic acid, pimelic acid, suberic acid, azelaic acid, sebacic acid, chlorendic acid, 1,2,4-butane-tricarboxylic acid, decanedicarboxylic acid, octadecanedicarboxylic acid, dimeric acid, dimerized fatty acids, trimeric fatty acids, and fumeric acid), and alicyclic dicarboxylic acids (e.g. 1,3-cyclohexanedicarboxylic acid, and 1,4-cyclohexanedicarboxylic acid).

Examples of suitable polyols from which polyester polyols can be derived include aliphatic polyols, e.g., ethylene glycols, propane diols (e.g., 1,2-propanediol and 1,3-propanediol), butane diols (e.g., 1,3-butanediol, 1,4-butanediol, and 1,7-butanediol), 1,3-butenediol, 1,4-butenediol, 1,4-butynediol, pentane diols (e.g., 1,5-pentanediol), pentenediols, pentynediols, 1,6-hexanediol, 1,8-octanediol, 1,10-decanediol, neopentyl glycol, diethylene glycol, triethylene glycol, tetraethylene glycol, polyethylene glycols, propylene glycol, polypropylene glycols (e.g., dipropylene glycol and tripropylene glycol), neopentylglycol, 1,4-cyclohexanedimethanol, 1,4-cyclohexanediol, dimer diols, bisphenol A, bisphenol F, hydrogenated bisphenol A, hydrogenated bisphenol F, glycerol, tetramethylene glycol, polytetramethylene glycol, 3-methyl-1,5-pentanediol, 1,9-nonanediol, 2-methyl 1,8-octanediol, and trimethylolpropane, pentaerythritol, sorbitol, glucose, and combinations thereof

Examples of useful polyester polyols include polyglycol adipates, polyethylene terephthalate polyols, polycaprolactone polyols and polycaprolactone triols.

Suitable commercially available polyols include, e.g., polyester polyols available under the DESMOPHEN series of trade designations including, e.g., DESMOPHEN XF-7395-200, DESMOPHEN S-1011-P-210, DESMOPHEN S-1011-110 and DESMOPHEN S-1011-55 from Bayer Chemicals (Pittsburgh, Pa.), dimer acid-based polyester polyols available under the PRIPLAST series of trade designations including, e.g., PRIPLAST 3187, 3190, 3196, and 3197 from UNIQEMA (New Castle, Del.), polybutadiene polyols available under the trade designations POLYBD R-20LM, R-45HT, and R-45M from Cray Valley. (Exton, Pa.), and hydrogenated polybutadiene polyols available under the trade designation POLYTAIL from Mitsubishi Chemical Corp. (Japan).

Suitable polyether polyols include the products obtained from the polymerization of a cyclic oxide, e.g., ethylene oxide, propylene oxide, butylene oxide, and tetrahydrofuran, or by the addition of one or more such oxides to polyfunctional initiators having at least two active hydrogens, e.g., water, polyhydric alcohols (e.g., ethylene glycol, propylene glycol, diethylene glycol, cyclohexane dimethanol, glycerol, trimethylol-propane, pentaerythritol and Bisphenol A), ethylenediamine, propylenediainine, triethanolamine, and 1,2-propanedithiol. Particularly useful polyether polyols include, e.g., polyoxypropylene diols and triols, poly(oxyethylene-oxypropylene)diols and triols obtained by the simultaneous or sequential addition of ethylene oxide and propylene oxide to appropriate initiators and polytetramethylene ether glycols obtained by the polymerization of tetrahydrofuran.

Photoinitiator

The adhesive composition may further include a photoinitiator. The photoinitiator can be present in any part of the composition including, e.g., Part A, Part B, and combinations thereof. Preferred photoinitiators are capable of promoting free radical polymerization, crosslinking, or both, of the ethylenically unsaturated moiety on exposure to radiation of a suitable wavelength and intensity. The photoinitiator can be used alone, or in combination with a suitable donor compound or a suitable coinitiator. The photoinitiator and the amount thereof are preferably selected to achieve a uniform reaction conversion, as a function of the thickness of the composition being cured, as well as a sufficiently high degree of total conversion so as to achieve the desired initial handling strength (i.e., lap shear strength).

Useful photoinitiators include, e.g., “alpha cleavage type” photoinitiators including, e.g., benzoin, benzoin acetals (e.g., benzyl dimethyl ketal), benzoin ethers (e.g., benzoin ethyl ether, benzoin isopropyl ether, and benzoin isobutyl ether), hydroxy alkyl phenyl ketones (e.g., 1-hydroxycyclohexyl phenyl ketone, 2-hydroxy-2-methyl-1-phenylpropan-1-one, and 1-(4-isopropylphenyl)-2-hydroxy-2-methylpropan-1-one), benzoyl cyclohexanol, dialkoxy acetophenone derivatives (e.g., 2,2-diethoxyacetophenone), acylphosphine oxides (e.g., bis(2,4,6-trimethylbenzoyl)-phenylphosphine oxide, bis(2,6-dimethoxybenzoyl)-(2,4,4-trimethylpentyl)phosphine oxide, and 2,4,4-trimethylbenzoyl diphenylphosphine oxide), methyl thio phenyl morpholino ketones (e.g., 2-methyl-1-4(methylthio) and phenyl-2-morpholino-1-propanone), and morpholino phenyl amino ketones; hydrogen abstracting photoinitiators, which include a photoinitiator and a coinitiator, based on benzophenones, thioxanthones, benzyls, camphorquinones, and ketocoumarins; and combinations thereof. Preferred photoinitiators include acylphosphine oxides including, e.g., bis(2,4,6-trimethylbenzoyl)-phenylphosphine oxide, bis(2,6-dimethoxybenzoyl)-(2,4,4-trimethylpentyl)phosphine oxide, and 2,4,4-trimethylbenzoyl diphenylphosphine oxide.

Other suitable photoinitiators include, e.g., organic peroxides, azo compounds, quinones, nitroso compounds, acryl halides, hydrozones, mercapto compounds, pyrylium compounds, triacrylimidazoles, bisiinidazoles, chloroalkytriazines, benzoin ethers, benzil ketals, thioxanthones, and acetophenone derivatives, and mixtures thereof.

Useful commercially available photoinitiators are available under the following trade designations IRGACURE 369 morpholino phenyl amino ketone, IRGACURE 819 bis(2,4,6-trimethylbenzoyl)-phenylphosphine oxide, IRGACURE CGI 403 bis(2,6-dimethoxybenzoyl)-(2,4,4-trimethylpentyl)phosphine oxide, IRGACURE 651 benzyl dimethyl ketal, IRGACURE 1841-hydroxycyclohexyl phenyl ketone, and IRGACURE 29594-(2-hydroxyethoxyl)phenyl-(2-hydroxy-2-methylpropyl)ketone, DAROCUR 1173 2-hydroxy-2-methyl-1-phenyl-propan-1-one, which is also known as hydroxymethylphenylpropanone, DAROCUR 4265 50:50 blend of 2-hydroxy-2-methyl-1-phenylpropan-1-one and 2,4,6-trimethylbenzoyidiphenylphosphine oxide, and CGI1700 25:75 blend of bis(2,6-dimethoxybenzoyl)-2,4,4-trimethylpentylphosphine and 2-hydroxy-2-methyl-1-phenylpropan-1-one, all of which are available from BASF.

The photoinitiator is preferably present in an amount sufficient to provide the desired rate of photopolymerization. The amount will depend, in part, on the light source, the thickness of the layer to be exposed to radiant energy and the extinction coefficient of the photoinitiator at the wavelength. Typically, the photoinitiator will be present in an amount up to about 5% by weight, or from about 0.01% by weight, or about 0.1% by weight, or about 0.2% by weight to no greater than about 5% by weight, based on the weight of the composition.

Optional Radiation Polymerizable Component

The adhesive composition can optionally include, in either Part A or Part B, an additional radiation polymerizable component that is different from the above-described radiation polymerizable polyisocyanate prepolymer in Part A. The optional radiation polymerizable component includes at least two radiation polymerizable functional groups that are polymerizable by UV or electron beam radiation. The optional radiation polymerizable component, however, does not include active hydrogen, therefore, is also different from the above described radiation polymerizable compound. The optional radiation polymerizable component can include any level of radiation polymerizable functionality including mono-, di-, tri-, tetra-, and higher functionality. Suitable examples of optional radiation polymerizable components with multiple radiation polymerizable functional groups include (meth)acrylate esters including, e.g., esters of acrylic acid and methacrylic acid prepared from acrylic acid and/or methacrylic acid and aliphatic alcohols, aromatic polyols, aliphatic polyols, cylcoaliphatic polyols, and combinations thereof, (meth)acrylate esters of polyether alcohols, urethane (meth)acrylate oligomers, epoxy(meth)acrylate oligomers, and combinations thereof.

Useful acrylate esters of aliphatic alcohols include, e.g., isobornyl(meth)acrylate, 2-ethoxyethoxy ethyl(meth)acrylate, and combinations thereof. Useful acrylate esters of aliphatic diols include, e.g., neopentyl glycol di(meth)acrylate, 1,6-hexanediol di(meth)-acrylate, trimethylolpropane tri(meth)acrylate, pentaerythritol tetra(meth)acrylate, and (meth)acrylate esters of sorbitol and of other sugar alcohols. These (meth)acrylate esters of aliphatic and cycloaliphatic diols may be modified with an aliphatic ester or with an alkylene oxide. The acrylates modified by an aliphatic ester include, e.g., neopentyl glycol hydroxypivalate di(meth)acrylate, caprolactone-modified neopentyl glycol hydroxypivalate di(meth)acrylates, and combinations thereof. The alkylene oxide-modified acrylate compounds include, e.g., ethylene oxide-modified neopentyl glycol di(meth)acrylates, propylene oxide-modified neopentyl glycol di(meth)acrylates, ethylene oxide-modified 1,6-hexanediol di(meth)acrylates or propylene oxide-modified 1,6-hexanediol di(meth)acrylates, and combinations thereof.

Suitable acrylate monomers derived from polyether polyols include, e.g., neopentyl glycol-modified trimethylolpropane di(meth)acrylates, polyethylene glycol di(meth)acrylates, polypropylene glycol di(meth)acrylates and the like. Trifunctional and higher polyfunctional acrylate monomers include, e.g., trimethylolpropane tri(meth)acrylate, pentaerythritol tri(meth)acrylate, dipentaerythritol tetra(meth)acrylate, dipentaerythritol penta(meth)acrylate, dipentaerythritol hexa(meth)acrylate, caprolactone-modified dipentaerythritol hexa(meth)acrylate, pentaerythritol tetra(meth)acrylate, tris[(meth)acryloxyethyl]isocyanurate, caprolactone-modified tris[(meth)acryloxyethyl]isocyanurates or trimethylolpropane tetra(meth)acrylate, and combinations thereof.

Suitable polyfunctional (meth)acrylate monomers include, e.g., tripropylene glycol diacrylate, neopentyl glycol propoxylate di(meth)acrylate, trimethylolpropane tri(meth)acrylate, and pentaerythritol triacrylate, and combinations thereof

Other Additives

The adhesive composition may also include other additives including, e.g., antioxidants, plasticizers, tackifying agents, adhesion promoters, non-reactive resins, ultraviolet light stabilizers, catalysts, rheology modifiers, biocides, corrosion inhibitors, dehydrators, organic solvents, colorants (e.g., pigments and dyes), fillers, surfactants, flame retardants, waxes, and mixtures thereof. These additives can be present in Part A, or Part B, or a combination of both. These additives, when present, are preferably selected to have limited UV absorption to maximize the amount of light transmitted through the material and available for the photoinitiator molecules to initiate the photopolymerization process.

The adhesive can optionally include a plasticizer. Suitable plasticizers include, e.g., phthalates, benzoates, sulfonamides, and mixtures thereof, and epoxidized soybean oil. Useful sources of dioctyl and diisodecyl phthalate include those available under the trade designations JAYFLEX DOP and JAYFLEX DIDP from Exxon Chemical. Useful dibenzoates are available under the trade designations BENZOFLEX 9-88, BENZOFLEX 50 and BENZOFLEX 400 from Eastman Chemical Co. Soybean oil is commercially available, e.g., from Dow Chemical under the trade designation FLEXOL EPO.

Plasticizer, when present, is preferably present from about 0.25% by weight to about 10% by weight, no greater than about 5% by weight, no greater than about 3% by weight, or even from about 0.5% by weight to 2% by weight.

The adhesive can optionally include a filler. Suitable fillers include, e.g., fumed silica, precipitated silica, talc, calcium carbonates, carbon black, alumina silicates, clay, zeolites, ceramics, mica, titanium dioxide, and combinations thereof. When present, the composition preferably includes filler in an amount of at least 0.5% by weight, from about 1% by weight to about 50% by weight, or even from about 5% by weight to about 10% by weight. For most typical applications no filler would be used to maintain transparency.

The adhesive can optionally include thermoplastic polymers including e.g., ethylenevinyl acetate, ethylene-acrylic acid, ethylenemethacrylate and ethylene-n-butyl acrylate copolymers, polyvinyl alcohol, hydroxyethylcellulose, hydroxylpropylcellulose, polyvinyl methyl ether, polyethylene oxide, polyvinylpyrrolidone, polyethyloxazolines, starch, cellulose esters, and combinations thereof.

### Methods of Making and Using

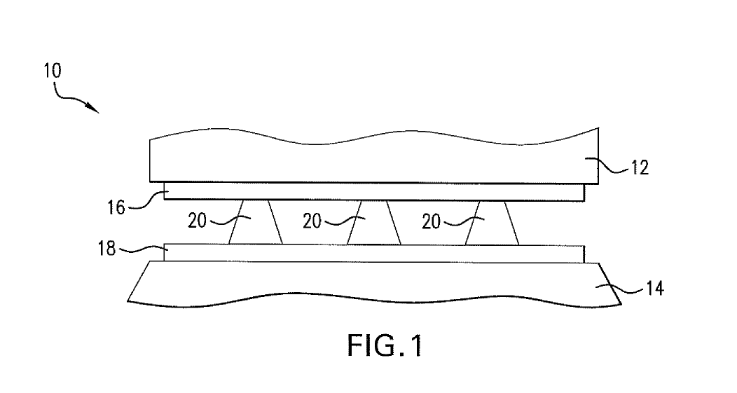

The disclosed adhesives can be used throughout the electronic manufacturing process. In some embodiments, the adhesive is used to bond multiple layers of an electronic assembly together. An exemplary multi-layered assembly is shown in FIG. 1. FIG. 1 shows a general assembly 10. The assembly 10 includes a first substrate 12 and a second substrate 14. The assembly 10 includes at least one electronic component 20 located between substrate 12 and substrate 14. It is understood that the assembly 10 can include more than one electronic component 20 as shown in FIG. 1.

The assembly 10 can optionally include a conductive layer 16 and 18 located between the electronic component 20 and the substrates 12 and 14. The conductive layer can be a conductive coating, a conductive ink, or a conductive adhesive. The conductive layer can be continuous along the substrate or discontinuous. An exemplary conductive layer is indium-tin-oxide (ITO). The electronic component 20 may be placed between the first substrate 12 and second substrate 14 in such a way as to be in direct or indirect electrical communication with the conductive layers 16 and 18. Direct communication can be intimate contact and indirect communication can be through a conductive material or medium. It may be desirable for one side of the electronic component to correspond to an anode side and the other side to correspond to a cathode side.

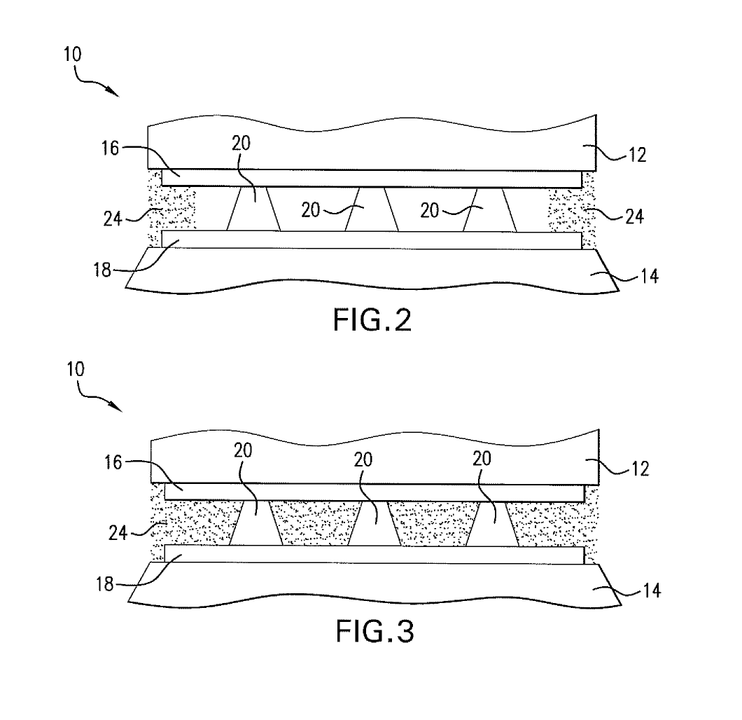

The adhesive can be used to bond or seal the layers of the assembly 10 together either by applying adhesive 24 to the edges of the assembly, as shown in FIG. 2, or by flooding the assembly with adhesive 24 as shown in FIG. 3.

The disclosed adhesive compositions can be used to manufacture electronic assemblies. When used with electronics, the adhesive composition can function as a conductive adhesive, semi-conductive adhesive, insulated adhesive, or sealant. The assembly can include a variety of electronics components. Exemplary electronic components include light-emitting diodes (LEDs), organic LEDs, high brightness LEDs, radio frequency identification (RFID) tags, electrochromatic displays, electrophoretic displays, batteries, sensors, solar cells, and photovoltaic cells.

Using adhesives to adhere substrates together or seal electronic components between two substrates can provide benefits like protection from elements such as moisture, UV radiation, oxygen, and the like. It can also provide protection from off-gasses from the materials in the assembly. It can also allow electrons to travel between the two substrates.

The adhesive composition includes a Part (A) and a Part (B) that are combined together shortly before applying the adhesive composition to a substrate. Part (A) and Part (B) are preferably not combined (or mixed together) for a long period of time before applying the mixture to the substrate because Part (A) and Part (B) start to cure shortly after being combined.

In some embodiments, the disclosed adhesives can be used to laminate various electronic components between two flexible substrates. In particular, the adhesive can be used to laminate at least two substrates together, at least one of the substrates has at least one electronic component thereon. Exemplary lamination processes include roll-to-roll manufacturing processes. The adhesive can be applied to a substrate in a variety of ways. For example, the adhesive can be applied in a liquid state. The adhesive may be applied using any suitable coating process including, e.g., air knife, trailing blade, spraying, jetting, brushing, dipping, doctor blade, roll coating, gravure coating, offset gravure coating, rotogravure coating, linear extruder, hand gun, extruder beads, and combinations thereof. The adhesive can also be printed on in a predetermined pattern. The adhesive can also be applied to a release liner where the adhesive/liner composite is adhered to a substrate.

The adhesive compositions are preferably a liquid at room temperature. Useful coating temperatures range from 65° F. to 170° F. The coat weight of the adhesive may vary broadly depending on the properties desired of the laminate, e.g., from about 1 mil to about 80 mils. Once coated on a first substrate, the first substrate is contacted with a second substrate. The second substrate may be of the same or different material relative to that of the first substrate but is sufficiently transparent to UV radiation. At least one of the two substrates has at least one electronic component thereon prior to applying the adhesive. The bonding process may be repeated a number of times, so that it is possible to produce articles which consist of more than two bonded layers.

In one embodiment, the method of making an electronic assembly includes coating a first substrate with the two part dual cure adhesive composition, exposing the coated adhesive composition to radiation, and then contacting the coated adhesive composition on the first substrate with a second substrate. At least one of the two substrates has at least one electronic component thereon prior to applying the adhesive. In another embodiment, the method of making an electronic assembly includes coating a first substrate with the two part dual cure adhesive composition, bringing a second substrate into contact with the coated adhesive on the first substrate, then exposing the laminated two substrates with the electronic component in between two substrates to radiation. At least one of the two substrates has at least one electronic component thereon prior to applying the adhesive.

Exposing the adhesive composition to radiation can occur before, after, or combination thereof, contacting the coated adhesive with the second substrate. The adhesive composition can be directly exposed to radiation or exposed to radiation through at least one of the substrates, which is sufficiently transparent to ultraviolet radiation. Exposing the adhesive composition to radiation initiates free radical polymerization of the radiation curable functional groups present in the composition, which imparts initial adhesive properties, e.g., lap shear strength, to the laminate. A relatively slower reaction involving the isocyanate groups and the hydroxyl groups present in the composition also occurs over time and provides the final performance properties of the adhesive composition and a laminate constructed therewith.

The composition can be radiation cured using, e.g., electron beam, ultraviolet light (i.e., radiation in the range from about 200 nm to about 400 nm), visible light (radiation having a wavelength in the range of from about 400 nm to about 800 nm) and combinations thereof. Useful sources of radiation include, e.g., extra high pressure mercury lamps, high pressure mercury lamps, medium pressure mercury lamps, metal halide lamps, microwave powered lamps, xenon lamps, laser beam sources including, e.g., excimer lasers and argon-ion lasers, and combinations thereof.

In some embodiments, the disclosed adhesives can be used to seal electronic components to provide further protection. In such applications the adhesive can be applied to the edges of the substrates only, or can be applied to the entire surface of the substrate, encapsulating the electronic component. The adhesive can be applied using any of the processes described above.

In some embodiments, the disclosed adhesives can be used to bond electronic components together as part of a manufacturing process. This application is similar to the laminating process in that two substrates are being bonded together. But, this process may be used with rigid and flexible substrates.

### Substrates

The adhesive composition can be used with a variety of rigid or flexible substrates. Exemplary substrates include flexible films such as metal foils (e.g., aluminum foil), polymer films and metalized polymer films prepared from polymers including, e.g., polyolefins (e.g., polypropylene, polyethylene, low density polyethylene, linear low density polyethylene, high density polyethylene, polypropylene, and oriented polypropylene; copolymers of polyolefins and other comonomers) metalized polyolefins (e.g., metalized polypropylene), metalized polyether terephthalate, ethylene-vinyl acetates, ethylene-methacrylic acid ionomers, ethylene-vinyl-alcohols, polyesters, e.g. polyethylene terephthalate, polycarbonates, polyamides, e.g. Nylon-6 and Nylon-6,6, polyvinyl chloride, polyvinylidene chloride, polylactic acid, cellulosics, and polystyrene, cellophane, and paper. The thickness of a film may vary, but flexible films typically have a thickness of less than about 0.5 millimeters, e.g. from about 10 micrometers to about 150 micrometers, more typically from about 8 micrometers to about 100 micrometers. The surface of the substrate can be surface treated to enhance adhesion using any suitable method including, e.g., corona treatments, chemical treatments and flame treatments.

Other suitable substrates include, e.g. woven webs, non-woven webs, paper, paperboard, and cellular flexible sheet materials (e.g., polyethylene foam, polyurethane foam and sponge and foam rubber). Woven and non-woven webs can include fibers including, e.g., cotton, polyester, polyolefin, polyamide, and polyimide fibers. Other substrates can include glass, transparent plastics such as polyolefins, polyethersulfones, polycarbonates, polyester, polyarylates, and polymeric films.

The above specification, examples and data describe the disclosure. Additional embodiments can be made without departing from the spirit and scope of the disclosure. All parts, ratios, percents, and amounts stated in the examples are by weight unless otherwise specified.

### EXAMPLES

### Test Methods

### Lap Shear Strength

Lap shear strength is determined according to ASTM D3163 in which the test specimen is constructed to have 5 mil coating of adhesive on a first 10 mil thick polyethylene terephthalate (PET) substrate laminated to a second 10 mil thick polyethylene terephthalate (PET) substrate with a 1 inch×1 inch substrate overlap.

The Maximum Load is determined and results are reported as lap shear strength in units of g/in². Reporting an average of three samples.

### Moisture Vapor Transmission Rate (MVTR)

Moisture vapor transmission rate (MVTR) is determined according to ASTM F1249-90 entitled, “Standard Test Method for Water Vapor Transmission Rate Through Plastic Film and Sheeting using a Modulated Infrared Sensor.” The test is conducted at approximately 37° C. (100° F.) and 90% relative humidity on an adhesive sample in the form of a film having a specified thickness.

### Peel Adhesion Test Method

T-peel strength is deter mined according to ASTM D1876-01 entitled, “Standard Test Method for Peel Resistance of Adhesives,” in which the test specimen is constructed to have 5 mil coating of an adhesive on a first 10 mil thick polyethylene terephthalate (PET) substrate laminated to a second 10 mil thick polyethylene terephthalate (PET) substrate with a 1 inch×1 inch substrate overlap.

The peel speed is 12 inches per minute. The results are reported in grains per lineal inch. Reporting an average of three samples.

### % NCO

Isocyanate percentage (% NCO) present in the adhesive composition is determined by first dissolving the prepolymer in toluene, reacting a predetermined volume of the prepolymer/toluene solution with a predetermined volume of a dibutylamine solution. The amine reacts with the isocyanate groups. The excess amine is then titrated with a predetermined solution of hydrogen chloride. The volume of the hydrogen chloride solution is then used to calculate the % NCO present in the composition.

### Viscosity

The viscosity of the adhesive composition is determined at 25° C. using a Brookfield Thermosel viscometer with a number 6 spindle.

### Example 1

Part A was prepared, as set forth in Table 1, by charging DESMOPHEN 5-1011-210 polyester polyol (Bayer Corporation, Pittsburgh, Pa.) to a reactor and heating to 130° F. A nitrogen purge was started and continued during the process. LUPRANATE MI monomeric 2,4′-diphenylmethane diisocyanate (MDI) (BASF Corporation, Syandotte, Mich.) was then added to the reactor in an amount sufficient to achieve at a stoichiometric NCO/OH ratio of from 2/1 (NCO/OH) to 2.5/1 (NCO/OH). The mixture was agitated and the temperature was raised to from 160° F. to 170° F. The reaction was completed in from one to two hours. The % NCO was checked periodically to determine if the reaction was completed, i.e., the target % NCO was obtained. The agitation was then stopped and 2-hydroxyethyl acrylate (HEA) (Dow Chemical Company, Midland, Mich.) was added to the reactor and allowed to react while maintaining the temperature from 160° F. to 170° F. The second reaction was completed in from 1 to 2 hours. The % NCO was checked to determine if the reaction was completed. The agitation was then stopped and additional LUPRANATE MI monomeric MDI was added to the reactor. The agitation was then restarted and continued until the mixture was homogeneous.

Part B was prepared by combining 97.45% DESMOPHEN XF-7395-200 polyester polyol with a hydroxyl number of approximately 200, 0.05% bismuth/zinc salt (catalyst) and 2.5% DAROCUR 1173 photoinitiator.

Part A was mixed with Part B to provide a stoichiometric ratio of NCO:OH of 1.4:1.0 immediately prior to coating.

Laminate 1 was prepared according to herein described Lap Shear Strength and Peel Adhesion test methods by coating an adhesive composition on the first PET substrate, then laminating the coated first substrate with the second substrate. Thereafter, the laminate was exposed to radiation from a medium pressure mercury lamp having a power of 300 watts per inch at a conveyor speed of 100 feet per minute.

Laminate 2 was prepared by coating an adhesive composition on the first PET substrate, then, exposing the coated adhesive on the first substrate to radiation from a medium pressure mercury lamp having a power of 300 watts per inch at a conveyor speed of 100 feet per minute. Thereafter, the first substrate with partially cured adhesive composition was laminated with the second PET substrate.

Laminates 1 and 2 were tested according to the herein described Lap Shear Strength test method and the Peel Strength test method, and the results are set forth in Table 2 below.

### Example 2

Part A as set forth in Table 1, Part B, adhesive composition, Laminate 1 and Laminate 2 were prepared according to the same procedure as that of Example 1, except that in Part A, DESMODUR N3600 monomeric homopolymer of hexamethylene diisocyanate was used in stead of LUPRANATE MI monomeric 2,4′-diphenylmethane diisocyanate (MDI).

Laminates 1 and 2 were tested according to the herein described Lap Shear Strength test method and the Peel Strength test method, and the results are set forth in Table 2 below.

### Example 3

Part A as set forth in Table 1, Part B, adhesive composition, Laminate 1 and Laminer 2 were prepared according to the same procedure as that of Example 1, except that in Part A, DESMODUR W monomeric dicyclohexylmethane diisocyanate was used in stead of LUPRANATE MI monomeric 2,4′-diphenylmethane diisocyanate (MDI).

Laminates 1 and 2 were tested according to the herein described Lap Shear Strength test method and the Peel Strength test method, and the results are set forth in Table 2 below.

TABLE 1
Part A Prepolymers of Examples 1-3

| | Ex 1 | Ex 2 | Ex 3 |
|---|---|---|---|
| DESMOPHEN S-1011-210 | 25.40 | | 23.75 |
| DESMOPHEN S-1011-55 | | 10.24 | |
| LUPRANATE MI | 35.50 | | |
| DESMODUR N3600 | | 43.71 | |
| DESMODUR W | | | 36.71 |
| 2-HEA | 8.60 | 8.83 | 8.13 |
| 2nd Charge Iso amount | | | |
| LUPRANATE MI | 30.50 | | |
| DESMODUR N3600 | | 37.22 | |
| DESMODUR W | | | 31.41 |
| | 100.00% | 100.00% | 100.00% |
| Final % NCO | 15.00% | 15.50% | 14.90% |

TABLE 2

| Example 1 | | Example 2 | | Example 3 | |
|---|---|---|---|---|---|
| Laminate 1 | Laminate 2 | Laminate 1 | Laminate 2 | Laminate 1 | Laminate 2 |

Lap Shear Strength

| | | | | | | |
|---|---|---|---|---|---|---|
| Immediately after | 121.07 | | 0 | | 0 | |
| laminating, no UV | | | | | | |
| Immediately after | 151.33 | 1165.27 | 1543.60 | 60.53 | 2966.13 | 30.27 |
| UV exposure | | | | | | |
| After 24 hrs. | 5463.13 | 2254.87 | 1876.53 | 514.53 | 7642.33 | 1558.73 |
| After 7 days | 42161.47 | 10956.53 | 65330.60 | 30009.40 | 66995.27 | 49743.27 |

T-Peel Strength

| | | | | | | |
|---|---|---|---|---|---|---|
| Immediately after | 2.27 | | 0 | | 0 | |
| laminating, no UV | | | | | | |
| Immediately after | 7.57 | 59.78 | 0.80 | 1.41 | 1.08 | 1.31 |
| UV exposure | | | | | | |
| After 24 hrs. | n/t | n/t | 1.33 | 2.29 | 3.47 | 2.81 |
| After 7 days | 366.72 | 301.15 | 296.01 | 137.57 | 70.98 | 64.32 |

*n/t: not tested

We claim:

1. A method of making an electronic assembly comprising:
applying a two-part dual-cure adhesive composition to at least a portion of a first substrate, the adhesive composition comprising a Part (A) that comprises a radiation polymerizable polyisocyanate prepolymer and a Part (B) that comprises a polyol; and
contacting the adhesive on the first substrate with at least a portion of a second substrate, at least one of the first and second substrates comprising at least one electronic component prior to applying the adhesive composition.

2. The method of claim 1, wherein the Part (A) further comprises an isocyanate monomer or an isocyanate-terminated prepolymer, which is not radiation polymerizable.

3. The method of claim 1, wherein either Part (A) or Part (B) further comprises a radiation polymerizable component selected from the group consisting of an acrylate monomer, acrylate polymer, acrylate oligomer, and combinations thereof.

4. The method of claim 1, wherein the radiation polymerizable polyisocyanate prepolymer comprises radiation functional groups selected from the group consisting of acrylate, alkenyl, styrene, and combinations and derivatives thereof.

5. The method of claim 1, wherein the radiation polymerizable polyisocyanate prepolymer includes a reaction product of a radiation polymerizable compound and an aliphatic polyisocyanate prepolymer.

6. The method of claim 1, further comprising exposing the adhesive composition to radiation prior to or after contacting the adhesive on the first substrate with the second substrate.

7. The method of claim 2, wherein the isocyanate-terminated prepolymer is a reaction product of an aliphatic isocyanate and a polyol.

8. The method of claim 2, wherein the isocyanate monomer is an aliphatic isocyanate.

9. The method of claim 1, wherein the first and second substrates are of the same or different material and are independently selected from the group consisting of polyethylene, polyethylene terephthalate, polyethylene naphthalate, and mixtures thereof.

10. The method of claim 1, wherein the electronic component is selected from the group consisting of a light-emitting diode (LED), a high brightness light-emitting diode (LED), an organic light-emitting diode (LED), a radio frequency identification (RFID tag, an electro chromic display, an electrophoretic display, a battery, a sensor, a solar cell, and a photovoltaic cell.

11. The method of claim 1, wherein the adhesive composition further comprises a photoinitiator.

12. An electronic assembly comprising:
a first substrate;
a second substrate;
at least one electronic component located between the first and the second substrates; and
an adhesive composition comprising a dual cure reaction product of a Part (A) that comprises a radiation polymerizable polyisocyanate prepolymer and a Part (B) that comprises a polyol,
at least a portion of the first substrate being bonded to at least a portion of the second substrate with the adhesive composition.

13. The assembly of claim 12, wherein Part (A) of the adhesive composition further comprises an isocyanate-terminated prepolymer or an isocyanate monomer.

14. The assembly of claim 12, wherein the radiation functional groups of the radiation polymerizable polyisocyanate prepolymer are selected from the group consisting of acrylate, alkenyl, and styrene and mixtures and derivatives thereof.

15. The assembly of claim 12, wherein either Part (A) or Part (B) further comprises a radiation polymerizable component selected from the group consisting of an acrylate monomer, acrylate polymer, acrylate oligomer, and mixtures thereof.

16. The assembly of claim 12, wherein the first or second substrates are of the same or different material and are independently selected from the group consisting of polyethylene, polyethylene terephthalate, polyethylene naphthalate, and mixtures thereof.

17. The assembly of claim 12, wherein the electronic component is selected from the group consisting of a light-emitting diode (LED), a high brightness light-emitting diode (LED), an organic light-emitting diode (LED), a radio frequency identification (RFID) tag, an electro chromic display, an electrophoretic display, a battery, a sensor, a solar cell, and a photovoltaic cell.

18. The assembly of claim 12, wherein the isocyanate-terminated prepolymer is a reaction product of an aliphatic isocyanate and a polyol.

19. The assembly of claim 12, wherein the adhesive further comprises a photoinitiator.

20. The assembly of claim 12, wherein the adhesive further comprises an additive selected from the group consisting of antioxidants, plasticizers, tackifying agents, adhesion promoters, non-reactive resins, ultraviolet light stabilizers, catalysts, rheology modifiers, biocides, corrosion inhibitors, dehydrators, organic solvents, colorants, fillers, surfactants, flame retardants, waxes, and combinations thereof.
